(19) United States
(12) Patent Application Publication
(10) Pub. No.: US 2003/0076512 A1
(43) Pub. Date: Apr. 24, 2003

(54) System and method to automatically scale preformatted text within an electronic document for printing

(76) Inventor: John D. Laughlin, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/983,287

(22) Filed: Oct. 23, 2001

(51) Int. Cl. G06T 3/40; G06K 15/02

(52) U.S. Cl. 358/1.2; 358/1.11

(57) ABSTRACT

A method, a computer readable medium, a system and an apparatus for reducing clipping in a print job. In the method, a length of a line of text within a print job is determined. Additionally, a width of a print medium is determined. Furthermore, a clipping condition is determined to be present in response to the length of the line of text exceeding the width of the print medium. Moreover, the line of text is scaled in response to determining the clipping condition is present. The above mentioned method is further executed by computer instructions embedded within the computer readable medium. The system is configured to perform the above mentioned method utilizing a preformat detector configured to detect a clipping condition within a print job and a scaler configured to scale a line of text within the print job in response to the clipping condition being detected. The apparatus includes a printing device operable to perform the above mentioned method. In this regard, the apparatus receives a print job in markup language format from at least one of an application and an Internet appliance. A processing system within the printing device is configured to detect a clipping condition and modify the print job in response to detecting the clipping condition.

### FIELD OF THE INVENTION

This invention relates generally to electronic document printing, and more particularly to automatically scaling preformatted text within an electronic document.

### BACKGROUND OF THE INVENTION

Typically, when viewing a Web page with an application (e.g., a browser), the application dynamically formats text being output to the monitor (e.g., wraps the text appropriately to fit the size of the viewing window). Similarly, when printing a Web page, the application will typically wrap the text being printed to fit within the boundaries of the print media. However, preformatted text is not altered by the application, so it will not wrap lines or reformat the text to fit within the screen or on the printed page.

A Web designer may use preformatted text because the structure of the text is important. For example, in computer code and poetry, changing the structure of the text may alter the meaning. To preformat selected text, the Web designer may utilize preformatting “tags”. In hypertext markup language (“HTML”) preformatted text is indicated by a “tag” at the beginning (e.g., <pre>) and a “tag” at the end (e.g., </pre>). However, if a Web page designer chooses to preformat the Web page, the application must not dynamically format the output. As a result, a portion of the Web page may fall outside of the printable area. This portion of the Web page falling outside of the printable area is said to be “clipped”. The clipped portion of the Web page may be printed on a subsequent page or may not be printed at all. There are currently no printer options to ensure that preformatted text is not clipped.

### SUMMARY OF THE INVENTION

In one respect, the invention pertains to a method. In the method, a length of a line of text within a print job is determined. Additionally, a width of a print medium is determined. Furthermore, a clipping condition is determined to be present in response to the length of the line of text exceeding the width of the print medium. Moreover, the line of text is scaled in response to determining the clipping condition is present.

In another respect, the invention pertains to a computer readable medium on which is embedded computer instructions for executing a method. In the method, a length of a line of text within a print job is determined. Additionally, a width of a print medium is determined. Furthermore, a clipping condition is determined to be present in response to the length of the line of text exceeding the width of the print medium. Moreover, the line of text is scaled in response to determining the clipping condition is present.

In yet another respect, the invention pertains to a system. In the system, a preformat detector configured to detect a clipping condition within a print job is included in the system. Additionally, a scaler configured to scale a line of text within the print job in response to the clipping condition being detected is also included in the system.

In yet another respect, the invention pertains to an apparatus. The apparatus includes a printing device operable to receive a print job in markup language format from at least one of an application and an Internet appliance. Additionally, a processing system within the printing device configured to detect a clipping condition and modify the print job in response to detecting the clipping condition is also included in the apparatus.

In comparison to known prior art, certain embodiments of the invention are capable of achieving certain aspects, including some or all of the following: (1) reduces or eliminates clipping; (2) saves user time; and (3) reduces user frustration. Those skilled in the art will appreciate these and other aspects of various embodiments of the invention upon reading the following detailed description of a preferred embodiment with reference to the below-listed drawings.

### BRIEF DESCRIPTION OF THE DRAWINGS

FIG. 1 is a flow chart in accordance with an exemplary manner in which an embodiment of the invention may be practiced;

FIG. 2 is a block diagram illustrating an exemplary computing environment in which an embodiment of the invention may be practiced;

FIG. 3 is a block diagram illustrating an exemplary system in accordance with an embodiment of the invention illustrated in FIG. 1;

FIG. 4 is a block diagram illustrating an exemplary system in accordance with another embodiment of the invention illustrated in FIG. 1; and

FIG. 5 is a block diagram illustrating an exemplary system in accordance with yet another embodiment of the invention illustrated in FIG. 1.

### DETAILED DESCRIPTION OF A PREFERRED EMBODIMENT

For simplicity and illustrative purposes, the principles of the invention are described by referring mainly to an exemplary embodiment thereof, particularly with reference to a system for automatically scaling a preformatted Web page for printing. However, one of ordinary skill in the art would readily recognize that the same principles are equally applicable to, and can be implemented in, a system capable of printing any computer readable media, and that any such variations are within the scope of the invention. While in the following description numerous specific details are set forth in order to provide a thorough understanding of an embodiment of the invention, in other instances, well known methods and structures have not been described in detail so as not to obscure the invention. Furthermore, the terms “connected” and its variants, as used herein, mean connected directly or indirectly through an intermediate element.

Although printing Web pages is described herein, it is to be understood that the invention is not limited to printing Web pages, but rather, the invention may be configured to print any text capable of being printed by a computer. Accordingly, the system and method to automatically scale preformatted Web page text for printing described is for illustrative purposes only and thus not meant to limit the invention in any respect. Additionally, the invention may be practiced in a variety of forms, several of which are described below.

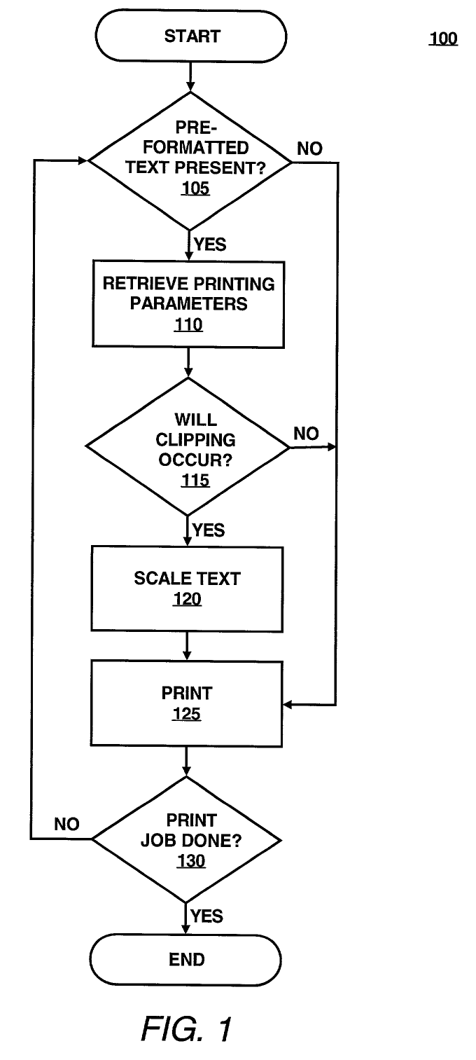

FIG. 1 is a flow chart of a method 100 in accordance with a manner in which an embodiment of the invention may be practiced. The method 100 may be initiated in response to receiving a print job (or document). The print job may specify one or more pages of content to be printed.

In response to receiving the print job, the method 100 determines if preformatted text is present within the print job, in step 105. The print job may be parsed to determine if one or more preformatted text indicators are present. For example, typically, in markup code language, a block of preformatted text is indicated by a “tag” at the beginning (“Tₛₜₐᵣₜ”), such as, “<pre>” and a “tag” at the end (“T_{end}”), such as, “</pre>”. If it is determined that no preformatted text is present, the method 100 proceeds to step 125 to print the document. If one or more preformatted text indicators are determined to be present, the method 100 proceeds to step 110.

In step 110, the method 100 retrieves printing parameters for the printer to which the print job is to be sent. Although FIG. 1 illustrates step 110 following step 105, as is well known to those having ordinary skill in the art, the printing parameters may be retrieved at any time prior to the step 115. The printing parameters may include one or more of the following pieces of information: paper width, paper height, print margins, font size, escapements, etc. A logical printed page may be generated based on the printing parameters. The logical, or virtual, printed page is defined as a computer model of the printed page. Following step 110, the method 100 proceeds to step 115.

In step 115, the method 100 determines if clipping will occur. The print job and the logical printed page may be accessed and compared. If it is determined that substantially no lines of the print job will exceed the width of the logical printed page, the method 100 proceeds to step 125 to print the document. If it is determined that one or more lines of the print job will exceed the width of the logical printed page, the method 100 proceeds to step 120.

In step 120, the method 100 may modify the font size of text within the one or more blocks of preformatted text to fit within the logical printed page. In this regard, the maximum width for any line of text (“Lₘₐₓ ”) between the Tₛₜₐᵣₜ and T_{end} may be determined. Based on the Lₘₐₓ and the width of the logical printed page, a scaling factor may be determined. The font size of text within the one or more blocks of preformatted text may be modified based on the scaling factor.

To ensure the text remains readable, the method 100 performs bounds checking. For example, if modifying the font size of the block of preformatted text reduces the effective font size of one or more characters below a predetermined size such as, for example, point size 6, the method 100 may increase the scaling factor to a value in which no character has a font size substantially below the predetermined size. The predetermined size may be calculated based on the smallest sized font that could reasonably be read by a user. In general, the predetermined size is based on the following factors: dimensions of smallest character of the font to be printed, system application, optimization of system, etc. The increase of the scaling factor may cause one or more lines of text in the block of preformatted text to exceed the logical printed page. In this regard, the method 100 may include a user modifiable option to remove the preformatted “tags”. For example, Tₛₜₐᵣₜ and T_{end} may be replaced with dynamic formatting text identifiers. Specifically, in HTML, the preformatting “tags”(e.g., <pre> and </pre>) may be replaced with paragraph “tags”(e.g., <p> and </p> respectively). The paragraph “tags” allow the application to dynamically wrap the text within the boundaries of the window or printed page respectively. It should be noted, however, that replacing preformatted “tags” with dynamic “tags” may alter the meaning of certain content in some situations. Following step 120, the method 100 proceeds to step 125 to print the document.

In step 125, the method 100 may forward some or all of the print job to the printer. The print job may include any modifications to the one or more blocks of preformatted text mentioned above.

In step 130, the method 100 may determine if the print job is completed. For example, if an “end of file” marker is encountered, the method 100 may end. If it is determined that the print job contains additional content, the method 100 may return to step 105.

In another form, the method 100 may reduce clipping of preformatted text comprised of non-scalable type font. The form of the method 100 described below is similar to the form of the method 100 described above and thus only those features which are reasonably necessary for a complete understanding are described below.

Typically, the size of fonts may be altered by modifying the font's associated size parameter. However, the size of non-scalable type font may not be modified in this manner. Thus, in step 120, the method 100 may, in response to detecting a non-scalable font type within the block of preformatted text, replace the non-scalable font type in the block of preformatted text with a relatively similar font type that is scalable.

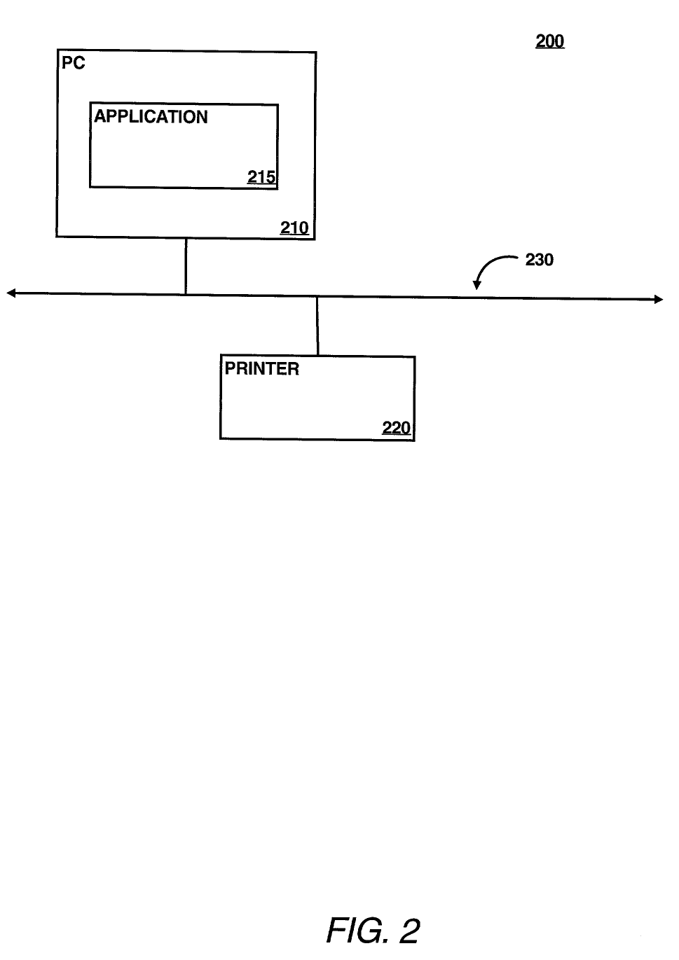

FIG. 2 is a block diagram illustrating a computer network 200 in accordance with an embodiment of the invention discussed in FIG. 1. As shown in FIG. 2, the computer network 200 may include a personal computer (“PC”) 210, a printer 220 and a connection 230. The computer network 200 may also include any reasonable number of additional components, e.g., clients, servers, printer spoolers, repeaters, hubs, bridges, routers, etc. The connection 230 is preferably configured to provide a communication path for one or more network devices to communicate with one or more other network devices. The connection 230 may be configured to operate over the Internet, public switched telephone network, a local area network or the like. Furthermore, it is within the scope of the invention that some or all of the functionality of the computer network 200 may be subsumed within a single device.

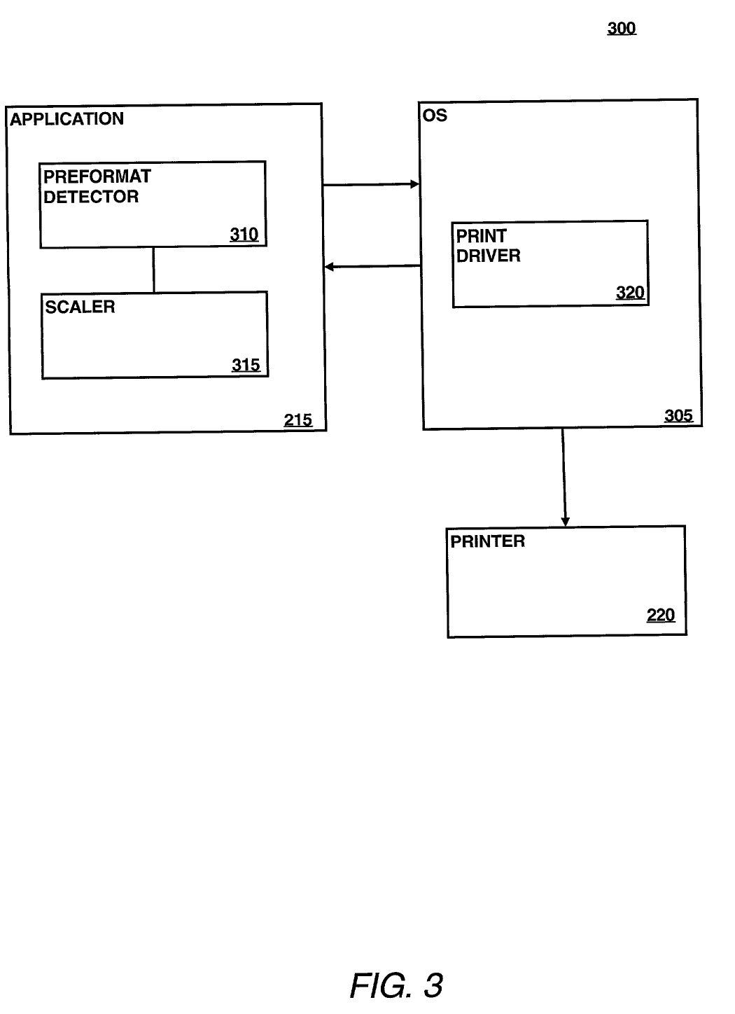

Although printing Web pages utilizing the connection 230 is described in this invention, it is to be understood that the invention is not limited to printing Web pages utilizing the connection 230, but rather, the invention may utilize any computer/printer configuration know to those skilled in the art. Accordingly, the computer network 200 described is for illustrative purposes only and thus not meant to limit the invention in any respect. Additionally, the functionality of the invention may be implemented in a variety of embodiments, some of which are described below in the detailed descriptions of FIGS. 3, 4, and 5.

The PC 210 may be configured to provide the capability to operate an application 215 (e.g., an Internet browser, a word processor, etc.). However, as is well known to those skilled in the art, the application 215 may be operated in various forms (e.g., client/server, stand alone, etc.) and it is to be understood that these various forms are within the scope of the invention. Additionally, the term application is not meant to be a limitation, but rather, describes any computer software or firmware capable of interacting with a document.

Although not shown in FIG. 2, the PC 210 may include an application programming interface (“API”), an operating system (“OS”), a graphic device interface (“GDI”) and a printer driver. The application 215 may be configured to communicate with the API, the GDI, the OS and/or the printer driver. In various forms, the functionality of the method 100, as described in FIG. 1, may be present in, or distributed across, one or more of: the application 215, the API, the OS, the GDI, printer firmware and the print driver.

In a preferred form, the application 215 may be capable of providing a user with the capacity to access the Web, display a selected Web page and initiate a print job of the selected Web page. The application 215 may further be configured with a user interface (“UI”). The UI may be configured to provide the user with the capacity to select printing options. The printing options may include: scale preformatted text (yes/no), dynamically format preformatted text (yes/no), etc.

Additionally, the computer network 200 may be configured with a parser capable of identifying specified preformatted text indicators in response to receiving a print job. The computer network 200 may further be configured to retrieve information from a printer configuration file or access the printer driver to obtain substantially the same information. The printer configuration file may include the following information: printer name, margin sizes, etc.

Moreover, the computer network 200 may be configured with one or more algorithms and associated programmed intelligence to perform the processes as described in the method 100 of FIG. 1. The computer network 200 may further be configured to forward the print job with any modifications to the printer 220.

In yet another form, the computer network 200 may be configured with one or more algorithms and associated programmed intelligence to modify the printing parameters as described in the method 100.

FIG. 3 is a block diagram illustrating a system 300 in accordance with an embodiment of the invention illustrated in FIG. 1. Additionally, the system 300 is a more detailed diagram of the computer environment illustrated in FIG. 2. Accordingly, the following description of FIG. 3 will be made with particular reference to those features illustrated in FIGS. 1 and 2. As shown in FIG. 3, the system 300 may include the printer 220, the application 215 and an operating system (“OS”) 305. The application 215 may include a preformat detector 310 and a scaler 315. The OS 305 may include a print driver 320. The various parts of the system 300 may be connected with each other and be capable of communicating with each other.

In a preferred form, the application 215 may be at least configured to perform the functions of known Web browsers such as NETSCAPE™ NAVIGATOR™, MICROSOFT™ EXPLORER™ and the like. In this regard, the application 215 maybe configured to initiate the print job and forward the print job to the print driver 320. The application 215 may be further configured to query the print driver 320 for the printing parameters, as well as to receive, store and allow access to the printing parameters.

The preformat detector 310 may be configured to access a print job in response to initiation by the application 215 and parse the print job to determine if one or more preformatted text identifiers are present. The preformat detector 310 may be further configured to forward the print job to the scaler 315 and/or the print driver 320.

The scaler 315 may be configured to access the printing parameters. The scaler 315 may be further configured to determine the logical printed page based on the printing parameters. Additionally, the scaler 315 may be configured to receive the print job from the preformat detector 310 and determine if clipping will occur. For example, the scaler 315 may generate the logical printed page (e.g., a virtual printed page) based on the print job and the printing parameters and determine if content exceeds the logical printed page. The scaler 315 may modify the print job as described in FIG. 1 in response to detecting content being outside the logical printed page. The scaler 315 may forward the print job to the print driver 320 in response to substantially all content being located within the logical printed page.

The print driver 320 may be configured to at least perform the function of known print drivers. In this regard, the print driver 320 may be configured to accept the print job and forward data associated with the modified print job to the printer 220. The print driver 320 may be further configured to maintain printing parameters for the print job and one or more printers.

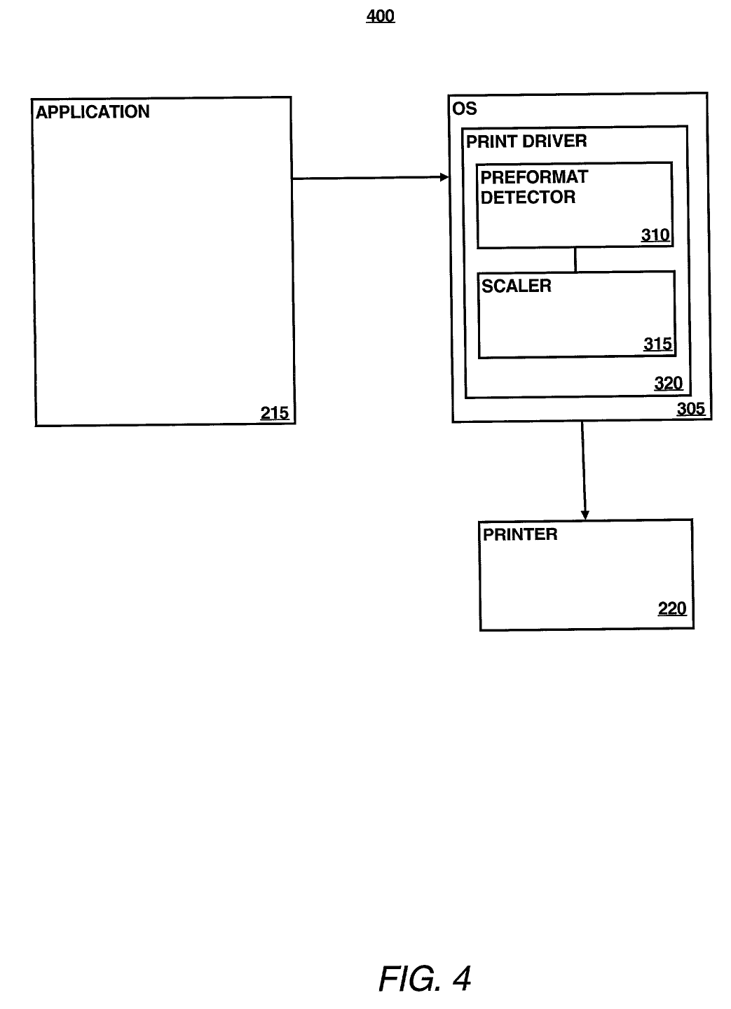

FIG. 4 is a block diagram illustrating a system 400 in accordance with a second embodiment of the invention illustrated in FIG. 1. Additionally, the system 400 is a more detailed diagram of the computer environment illustrated in FIG. 2. Accordingly, the following description of FIG. 4 will be made with particular reference to those features illustrated in FIGS. 1 and 2. Furthermore, the system 400 is similar to the system 300 and thus, only those features which are reasonably necessary for a complete understanding of the second embodiment are described below. As shown in FIG. 4, the system 400 may include the printer 220, the application 215 and the OS 305. The OS 305 may include the print driver 320. The print driver 320 may include the preformat detector 310 and the scaler 315. The various parts of the system 400 may be connected and capable of two way communication.

In a manner similar to the system 300, the print driver 320 of the system 400 may be configured to at least perform the function of known print drivers. In addition, the print driver 320 may be configured to accept the print job and modify the print job as required. In this regard, the preformat detector 310 and the scaler 315 may reduce the occurrence of clipping as described above. Thus, the application 215 may be configured to forward markup language (e.g., HTML, XML, etc.) to the print driver 320. The print driver 320 may be further configured to forward data associated with the modified print job to the printer 220.

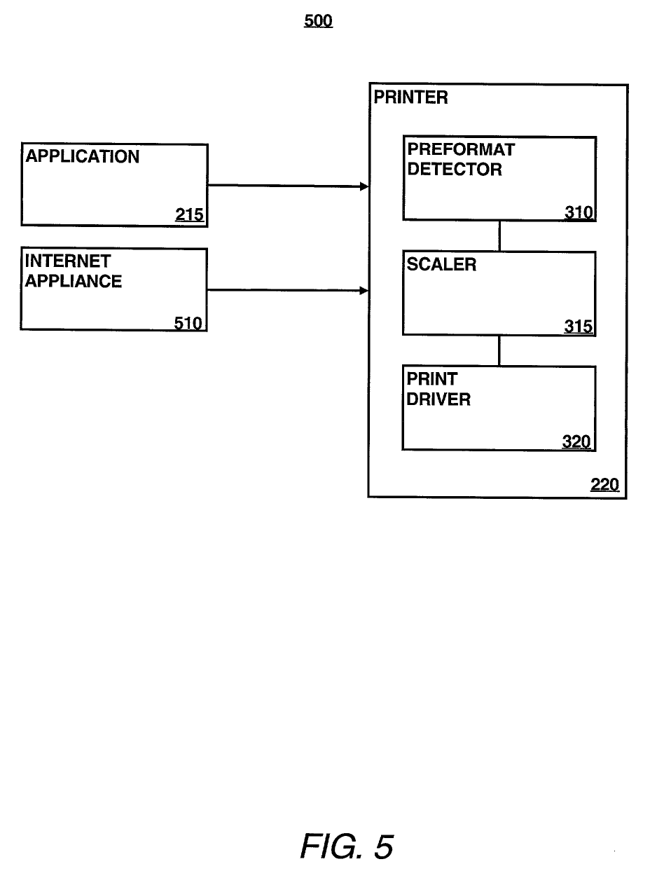

FIG. 5 is a block diagram illustrating a system 500 in accordance with a third embodiment of the invention illustrated in FIG. 1. Additionally, the system 500 is a more detailed diagram of the computer environment illustrated in FIG. 2. Accordingly, the following description of FIG. 5 will be made with particular reference to those features illustrated in FIGS. 1 and 2. Furthermore, the system 500 is similar to the systems 300 and 400 and thus, only those features which are reasonably necessary for a complete understanding of the second embodiment are described below. As shown in FIG. 5, the system 500 may include the printer 220, the application 215 and an Internet appliance 510 (e.g., personal digital assistant, Web TV, etc.). The various parts of the system 500 may be connected with each other either directly or indirectly and may be capable of communicating with each other.

In general, the system 500 may utilize a “native” markup language printing device as the printer 220. In this regard, firmware (e.g., controller, formatter and the like) of the printer 220 may include the preformat detector 310 and the scaler 315. Thus, the printer 220 may receive a print job in markup language format, detect and reduce the occurrence of clipping, and process or complete the print job.

The application 215 and Internet appliance 510 of the system 500 may be configured to forward markup language to the printer 220. The printer 220 may be configured to receive the markup language and in a manner similar to the system 300 and 400, the preformat detector 310 and the scaler 315 may reduce the occurrence of clipping as described above. The functionality of the print driver 320 may be subsumed within the firmware of the printer 220.

The method 100 can exist in a variety of forms both active and inactive. For example, they can exist as software program(s) comprised of program instructions in source code, object code, executable code or other formats. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of software program(s) on a CD ROM or via Internet download. In a sense, the Internet itself, as an abstract entity, is a computer readable medium. The same is true of computer networks in general.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method comprising:
determining a length of a line of text of a print job;
determining a width of a print medium;
determining a clipping condition is present in response to the length of the line of text exceeding the width of the print medium; and
scaling the line of text in response to determining the clipping condition is present.

2. The method according to claim 1, further comprising:
detecting a preformatted text indicator within the print job, wherein determining the length of the line of text comprises determining a length of a preformatted line of text in response to detecting the preformatted text indicator;
generating a logical printed page, wherein the logical printed page has a height and a width corresponding to the height and width of the print medium; and
determining whether the length of the preformatted line of text exceeds the width of the logical printed page.

3. The method according to claim 2, further comprising:
retrieving printing parameters; and
calculating the logical printed page based on the printing parameters.

4. The method according to claim 1, wherein the line of text is comprised of a scalable font, and scaling the line of text includes modifying a point size.

5. The method according to claim 4, further comprising:
determining a scaling factor based on the width of the print medium and the length of the line of text; and
modifying the point size of the line of text, wherein the font size is reduced based on the scaling factor.

6. The method according to claim 1, wherein the line of text is comprised of a non-scalable font, and scaling the line of text includes replacing the non-scalable font type with a scalable font type.

7. A computer readable medium on which is embedded a set of computer instructions for executing a method comprising:
determining a length of a line of text of a print job;
determining a width of a print medium;
determining a clipping condition is present in response to the length of the line of text exceeding the width of the print medium; and
scaling the line of text in response to determining the clipping condition is present.

8. The computer readable medium according to claim 7, further comprising:
detecting a preformatted text indicator within the print job, wherein determining the length of the line of text comprises determining a length of a preformatted line of text in response to detecting the preformatted text indicator;
generating a logical printed page, wherein the logical printed page has a height and a width corresponding to the height and width of the print medium; and
determining whether the length of the preformatted line of text exceeds the width of the logical printed page.

9. The computer readable medium according to claim 8, further comprising:
retrieving printing parameters; and
calculating the logical printed page based on the printing parameters.

10. The computer readable medium according to claim 7, wherein the line of text is comprised of a scalable font, and scaling the line of text includes modifying a point size.

11. The computer readable medium according to claim 10, further comprising:
determining a scaling factor based on the width of the print medium and the length of the line of text; and
modifying the point size of the line of text, wherein the font size is reduced based on the scaling factor.

12. The computer readable medium according to claim 7, wherein the line of text is comprised of a non-scalable font, and scaling the line of text includes replacing the non-scalable font type with a scalable font type.

13. A system comprising:
a preformat detector configured to detect a clipping condition within a print job; and
a scaler configured to scale a line of text within the print job in response to the clipping condition being detected.

14. The system according to claim 13, wherein the preformat detector is further configured to detect a preformatted text indicator within the print job.

15. The system according to claim 14, wherein the scaler is further configured to:
determine a length of a preformatted line of text in response to the detection of the preformatted text indicator;
generate a logical printed page having a height and a width corresponding to a height and width of a print medium; and
determine whether the length of the preformatted line of text exceeds the width of the logical printed page.

16. The system according to claim 15, wherein the scaler is further configured to retrieve printing parameters and calculate the logical printed page based on the printing parameters.

17. The system according to claim 13, wherein the scaler is further configured to modify a point size of the line of text.

18. The system according to claim 13, wherein the scaler is further configured to replace a non-scalable font type with a scalable font type.

19. An apparatus comprising:
a printing device operable to receive a print job in markup language format from at least one of an application and an Internet appliance; and
a processing system within the printing device configured to detect a clipping condition and modify the print job in response to detecting the clipping condition.
